(19) United States
(12) Patent Application Publication
(10) Pub. No.: US 2024/0323871 A1
(43) Pub. Date: Sep. 26, 2024

(54) AUTOMATIC GAIN CONTROL SLOT STRUCTURES FOR SIDELINK FREQUENCY RANGES

(71) Applicant: QUALCOMM Incorporated, San Diego, CA (US)

(72) Inventors: Chih-Hao LIU, San Diego, CA (US); Jing SUN, San Diego, CA (US); Xiaoxia ZHANG, San Diego, CA (US); Giovanni CHISCI, San Diego, CA (US)

(21) Appl. No.: 18/187,980

(22) Filed: Mar. 22, 2023

(51) Int. Cl. H04W 52/52; H04L 27/26; H04W 72/25

(52) U.S. Cl. CPC H04W 52/52; H04L 27/26025; H04W 72/25

(57) ABSTRACT

Various aspects of the present disclosure generally relate to wireless communication. In some aspects, a first user equipment (UE) may transmit, to a second UE, one or more automatic gain control (AGC) symbols at an AGC candidate location based at least in part on an AGC slot structure for a sidelink frequency range. The first UE may transmit, to the second UE, one or more of a physical sidelink control channel (PSCCH) transmission, a physical sidelink shared channel (PSSCH) transmission, or a physical sidelink feedback channel (PSFCH) transmission based at least in part on the AGC slot structure for the sidelink frequency range. Numerous other aspects are described.

### FIELD OF THE DISCLOSURE

Aspects of the present disclosure generally relate to wireless communication and to techniques and apparatuses for automatic gain control (AGC) slot structures for sidelink frequency ranges.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some implementations, an apparatus for wireless communication at a first user equipment (UE) includes a memory and one or more processors, coupled to the memory, configured to: transmit, to a second UE, one or more automatic gain control (AGC) symbols at an AGC candidate location based at least in part on an AGC slot structure for a sidelink frequency range; and transmit, to the second UE, one or more of a physical sidelink control channel (PSCCH) transmission, a physical sidelink shared channel (PSSCH) transmission, or a physical sidelink feedback channel (PSFCH) transmission based at least in part on the AGC slot structure for the sidelink frequency range.

In some implementations, an apparatus for wireless communication at a second UE includes a memory and one or more processors, coupled to the memory, configured to: receive, from a first UE, one or more AGC symbols at an AGC candidate location based at least in part on an AGC slot structure for a sidelink frequency range, an AGC training being based at least in part on the one or more AGC symbols at the AGC candidate location; and receive, from the first UE, one or more of a PSCCH transmission, a PSSCH transmission, or a PSFCH transmission based at least in part on the AGC slot structure for the sidelink frequency range.

In some implementations, a method of wireless communication performed by a first UE includes transmitting, to a second UE, one or more AGC symbols at an AGC candidate location based at least in part on an AGC slot structure for a sidelink frequency range; and transmitting, to the second UE, one or more of a PSCCH transmission, a PSSCH transmission, or a PSFCH transmission based at least in part on the AGC slot structure for the sidelink frequency range.

In some implementations, a method of wireless communication performed by a second UE includes receiving, from a first UE, one or more AGC symbols at an AGC candidate location based at least in part on an AGC slot structure for a sidelink frequency range, an AGC training being based at least in part on the one or more AGC symbols at the AGC candidate location; and receiving, from the first UE, one or more of a PSCCH transmission, a PSSCH transmission, or a PSFCH transmission based at least in part on the AGC slot structure for the sidelink frequency range.

In some implementations, a non-transitory computer-readable medium storing a set of instructions for wireless communication includes one or more instructions that, when executed by one or more processors of a first UE, cause the first UE to: transmit, to a second UE, one or more AGC symbols at an AGC candidate location based at least in part on an AGC slot structure for a sidelink frequency range; and transmit, to the second UE, one or more of a PSCCH transmission, a PSSCH transmission, or a PSFCH transmission based at least in part on the AGC slot structure for the sidelink frequency range.

In some implementations, a non-transitory computer-readable medium storing a set of instructions for wireless communication includes one or more instructions that, when executed by one or more processors of a second UE, cause the second UE to: receive, from a first UE, one or more AGC symbols at an AGC candidate location based at least in part on an AGC slot structure for a sidelink frequency range, an AGC training being based at least in part on the one or more AGC symbols at the AGC candidate location; and receive, from the first UE, one or more of a PSCCH transmission, a PSSCH transmission, or a PSFCH transmission based at least in part on the AGC slot structure for the sidelink frequency range.

In some implementations, a first apparatus for wireless communication includes means for transmitting, to a second apparatus, one or more AGC symbols at an AGC candidate location based at least in part on an AGC slot structure for a sidelink frequency range; and means for transmitting, to the second apparatus, one or more of a PSCCH transmission, a PSSCH transmission, or a PSFCH transmission based at least in part on the AGC slot structure for the sidelink frequency range.

In some implementations, a second apparatus for wireless communication includes means for receiving, from a first apparatus, one or more AGC symbols at an AGC candidate location based at least in part on an AGC slot structure for a sidelink frequency range, an AGC training being based at least in part on the one or more AGC symbols at the AGC candidate location; and means for receiving, from the first apparatus, one or more of a PSCCH transmission, a PSSCH transmission, or a PSFCH transmission based at least in part on the AGC slot structure for the sidelink frequency range.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIGS. 4-8 are diagrams illustrating examples associated with automatic gain control (AGC) slot structures for sidelink frequency ranges, in accordance with the present disclosure.

FIGS. 9-10 are diagrams illustrating example processes associated with AGC slot structures for sidelink frequency ranges, in accordance with the present disclosure.

FIGS. 11-12 are diagrams of example apparatuses for wireless communication, in accordance with the present disclosure.

### DETAILED DESCRIPTION

An automatic gain control (AGC) overhead may increase with higher numerologies. The higher numerologies, which may be associated with higher subcarrier spacings (SCS), may need additional AGC bits for AGC training. With the increased AGC overhead associated with the higher numerologies, a physical sidelink shared channel (PSSCH) or a physical sidelink control channel (PSCCH) (PSSCH/PSCCH) and a physical sidelink feedback channel (PSFCH) may not be able to fit in one slot, which may degrade a user equipment (UE) performance.

In some aspects described herein, a first UE may transmit, to a second UE, one or more AGC symbols at an AGC candidate location based at least in part on an AGC slot structure for a sidelink frequency range. The AGC candidate location may be associated with an AGC candidate symbol or an AGC candidate slot. In some cases, the AGC candidate location may be associated with multiple AGC candidate symbols or multiple AGC candidate slots. A periodicity of the AGC candidate location may be configured in terms of a quantity of slots. The AGC slot structure may be a dynamic AGC slot structure with common and periodic AGC candidate locations. The first UE and the second UE may be configured with the AGC slot structure (e.g., via a network node). The first UE may transmit, to the second UE, a PSCCH transmission, a PSSCH transmission, or a PSFCH transmission based at least in part on the AGC slot structure for the sidelink frequency range. The AGC slot structure with the common and periodic AGC candidate locations, which may be common for a PSSCH/PSCCH and a PSFCH, may reduce an AGC overhead, which may naturally be higher with higher numerologies, thereby improving an overall performance of the first UE and the second UE.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

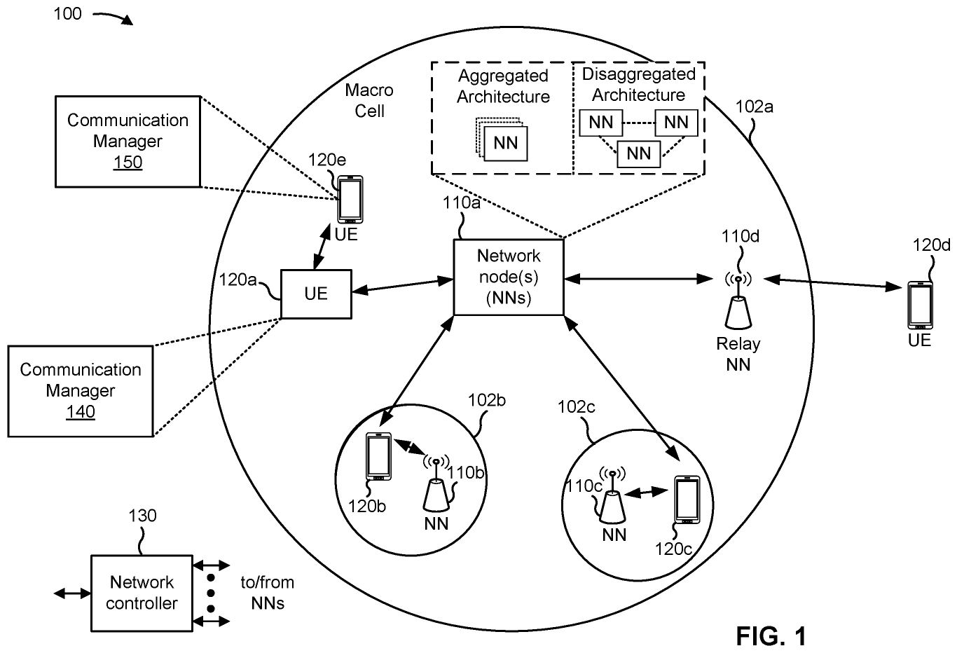

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120c), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage arcas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (cMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120c) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, a first UE (e.g., UE 120a) may include a communication manager 140. As described in more detail elsewhere herein, the communication manager 140 may transmit, to a second UE, one or more AGC symbols at an AGC candidate location based at least in part on an AGC slot structure for a sidelink frequency range; and transmit, to the second UE, one or more of a PSCCH transmission, a PSSCH transmission, or a PSFCH transmission based at least in part on the AGC slot structure for the sidelink frequency range. Additionally, or alternatively, the communication manager 140 may perform one or more other operations described herein.

In some aspects, a second UE (e.g., UE 120c) may include a communication manager 150. As described in more detail elsewhere herein, the communication manager 150 may receive, from a first UE, one or more AGC symbols at an AGC candidate location based at least in part on an AGC slot structure for a sidelink frequency range, an AGC training being based at least in part on the one or more AGC symbols at the AGC candidate location; and receive, from the first UE, one or more of a PSCCH transmission, a PSSCH transmission, or a PSFCH transmission based at least in part on the AGC slot structure for the sidelink frequency range. Additionally, or alternatively, the communication manager 150 may perform one or more other operations described herein.

As indicated above, FIG. 1 is provided as an example. Other examples may differ from what is described with regard to FIG. 1.

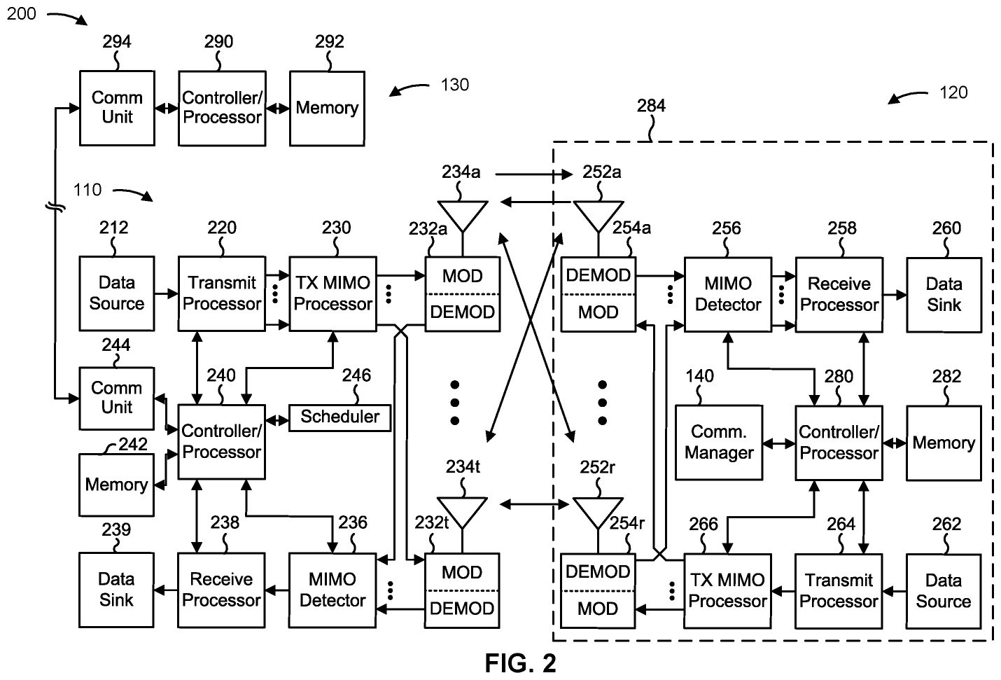

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

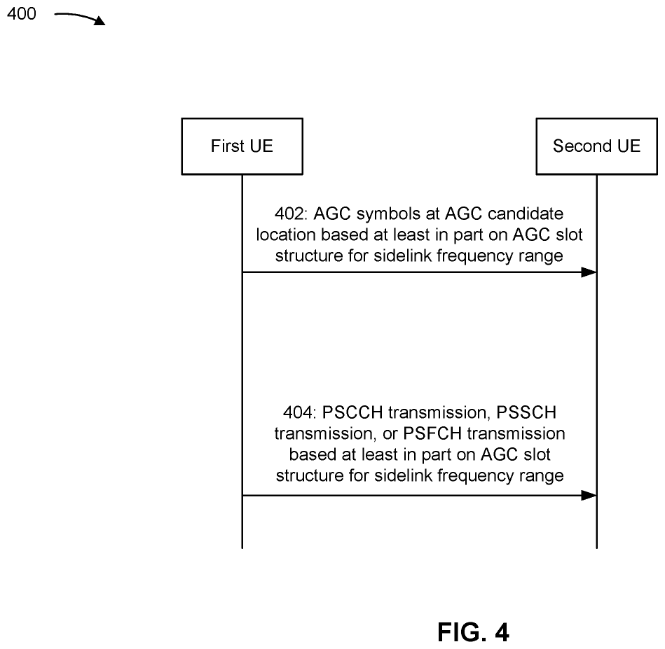

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-12).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-12).

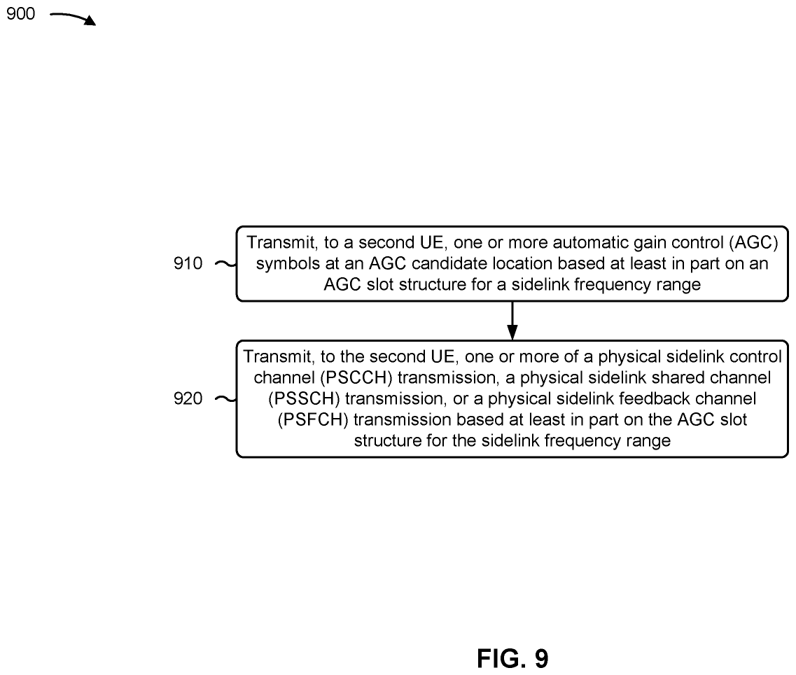

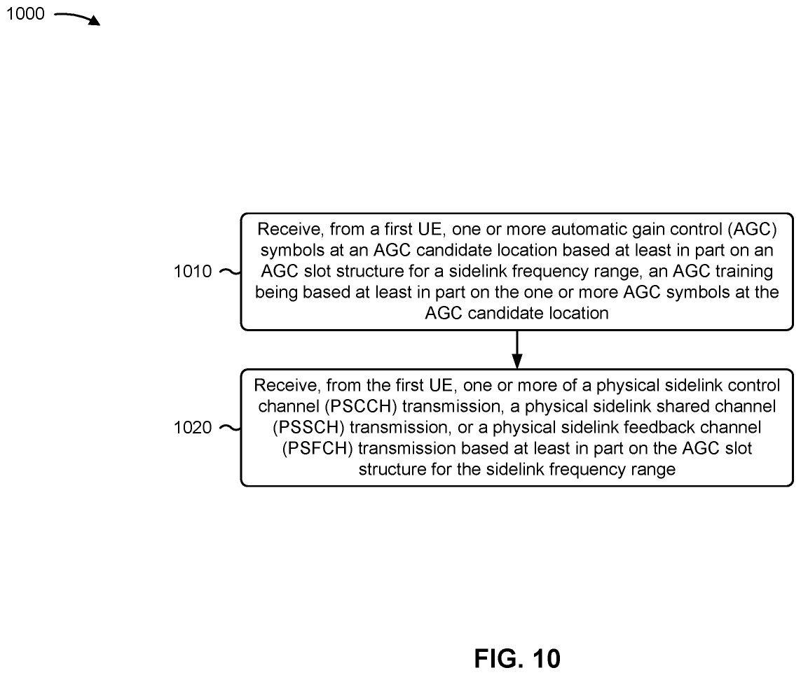

The controller/processor 240 of the network node 110, the controller/processor 280 of the UE 120, and/or any other component(s) of FIG. 2 may perform one or more techniques associated with AGC slot structures for sidelink frequency ranges, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, a first UE (e.g., UE 120a) includes means for transmitting, to a second UE, one or more AGC symbols at an AGC candidate location based at least in part on an AGC slot structure for a sidelink frequency range; and/or means for transmitting, to the second UE, one or more of a PSCCH transmission, a PSSCH transmission, or a PSFCH transmission based at least in part on the AGC slot structure for the sidelink frequency range. The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a second UE (e.g., UE 120e) includes means for receiving, from a first UE, one or more AGC symbols at an AGC candidate location based at least in part on an AGC slot structure for a sidelink frequency range, an AGC training being based at least in part on the one or more AGC symbols at the AGC candidate location; and/or means for receiving, from the first UE, one or more of a PSCCH transmission, a PSSCH transmission, or a PSFCH transmission based at least in part on the AGC slot structure for the sidelink frequency range. The means for the second UE to perform operations described herein may include, for example, one or more of communication manager 150, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (CNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

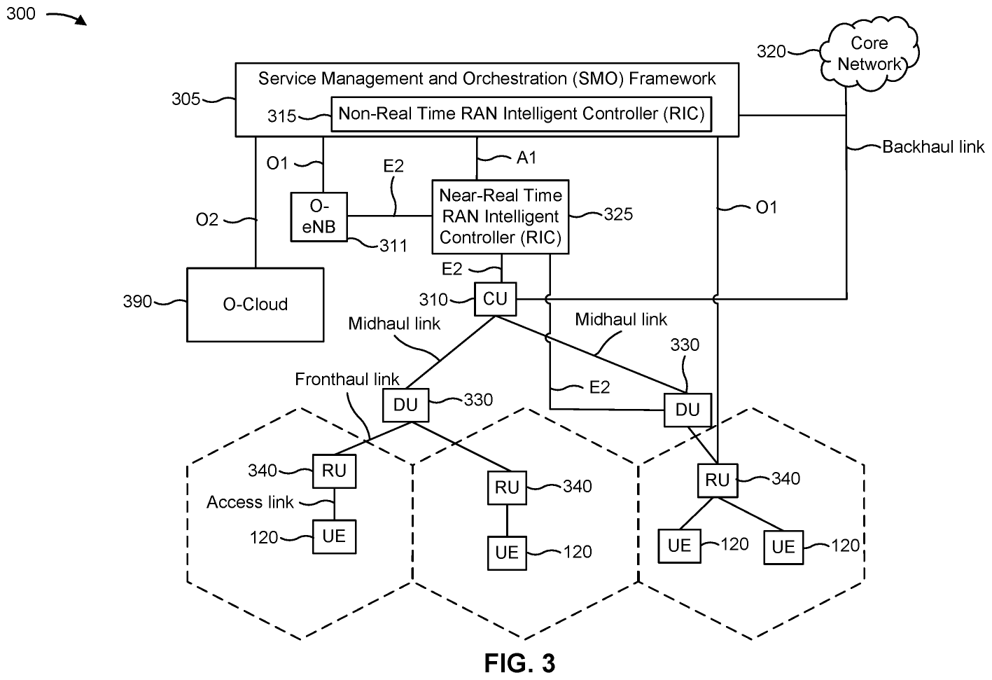

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 May communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-cNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

An RF timeline associated with a 60 GHz bandwidth may be defined. In an FR2-1 associated with a 120 kHz SCS, an on-to-off transient time may be 5 microseconds (us), an off-to-on transient time may be 5 us, a transmit-receive (Tx-Rx) switching time may be 7.015 us, an Rx-Tx switching time may be 7.015 us, an Rx-Rx beam switching time may be 200 nanoseconds (ns), and a Tx-Tx beam switching time may be 200 ns. In an FR2-2 associated with a 120 kHz SCS, an on-to-off transient time may be 5 us, an off-to-on transient time may be 5 us, a Tx-Rx switching time may be 7.015 us, an Rx-Tx switching time may be 7.015 us, an Rx-Rx beam switching time may be 200 ns, and a Tx-Tx beam switching time may be 200 ns. In an FR2-2 associated with a 480/960 kHz SCS, an on-to-off transient time may be 5 us (or an optional faster capability), an off-to-on transient time may be 5 us (or an optional faster capability), a Tx-Rx switching time may be 7.015 us, an Rx-Tx switching time may be 7.015 us, an Rx-Rx beam switching time may be between approximately 50 ns and 200 ns, and a Tx-Tx beam switching time may be between approximately 50 ns and 200 ns. The FR2-2 may only support unicast transmissions due to a relatively narrow beam nature of FR2-2.

A Tx/Rx switching time (or Tx-Rx switching gap) may be approximately 7 us, irrespective of the SCS. Symbol durations may be defined for different numerologies. For example, a symbol duration for a numerology associated with the 120 kHz SCS may be 8.33 us. A symbol duration for a numerology associated with the 480 kHz SCS may be 2.08 us. A symbol duration for a numerology associated with the 960 kHz SCS may be 1.04 us.

Multiple Tx/Rx gap symbols may be needed for higher numerologies. For example, at least 1, 4, or 8 gap symbols may be needed for the 120 kHz SCS, the 480 kHz SCS, or the 960 kHz SCS, respectively, based at least in part on the symbol durations associated with the different numerologies. However, the current sidelink slot structure with a gap symbol in each slot is inefficient for such higher numerologies.

An AGC settling time, for a single component carrier using a CP-OFDM waveform and at least a 10 resource block allocation, may be less than or equal to 35 us for a 15 kHz SCS, less than or equal to 35 us for a 30 kHz SCS, and less than or equal to 18 us for a 60 KHz SCS.

When an SCS is varied, a FFT length may be scaled proportionally, but a sampling range may remain the same. For the AGC settling time, the same quantity of samples for each SCS may be needed to achieve a certain level of accuracy. Other parameters, such as a hardware programming time or a hardware settling time, may remain SCS agnostic.

In some cases, an AGC settling time may be approximately 28.5 us, which may be irrespective of the SCS. In this case, for the 30 kHz SCS, the 60 kHz SCS, the 120 kHz SCS, the 480 kHz SCS, or the 960 kHz SCS, the quantity of OFDM symbols needed for AGC may be 1 symbol, 2 symbols, 4 symbols, 14 symbols, or 28 symbols, respectively.

With the increased AGC overhead (e.g., the increased quantity of AGC symbols) in higher numerologies in FR2 (e.g., 1, 2, 4, 14, or 28 symbols for AGC), an amount of overhead may need to be reduced, which may avoid transmitting AGC slots in the middle of a multiple slot PSSCH transmission over a link. With the increased AGC overhead, a PSFCH and a PSSCH/PSCCH may not be able to fit in one slot. Further, periodic PSFCH occasions may lack flexibility and efficiency, and the AGC overhead associated with PSFCHs may be relatively large for higher numerologies.

In various aspects of techniques and apparatuses described herein, a first UE may transmit, to a second UE, one or more AGC symbols at an AGC candidate location based at least in part on an AGC slot structure for a sidelink frequency range. The AGC candidate location may be associated with an AGC candidate symbol or an AGC candidate slot. A periodicity of the AGC candidate location may be configured in terms of a quantity of slots. The AGC slot structure may be a dynamic AGC slot structure with common and periodic AGC candidate locations. The first UE and the second UE may be configured with the AGC slot structure (e.g., via a network node). The first UE may transmit, to the second UE, a PSCCH transmission, a PSSCH transmission, or a PSFCH transmission based at least in part on the AGC slot structure for the sidelink frequency range. The AGC slot structure with the common and periodic AGC candidate locations, which may be common for a PSSCH/PSCCH and a PSFCH, may reduce an AGC overhead, which may naturally be higher with higher numerologics, thereby improving an overall performance of the first UE and the second UE.

In some aspects, with the increased AGC overhead in FR2-2, a PSSCH/PSCCH and a PSFCH may not be able to fit in one slot, so a common AGC structure may be considered for both the PSSCH/PSCCH and the PSFCH, which may allow the PSSCH/PSCCH and the PSFCH to fit in one slot. The common AGC structure, which may be for both the PSSCH/PSCCH and the PSFCH, may be associated with a dynamic slot structure for a sidelink FR2-2. Further, since periodic PSFCH occasions may lack flexibility and efficiency, a dynamic PSFCH may be considered, which may provide greater flexibility and efficiency for the UE and/or the network.

FIG. 4 is a diagram illustrating an example 400 associated with AGC slot structures for sidelink frequency ranges, in accordance with the present disclosure. As shown in FIG. 4, example 400 includes communication between a first UE (e.g., UE 120a) and a second UE (e.g., UE 120c). In some aspects, the first UE and the second UE may be included in a wireless network, such as wireless network 100.

As shown by reference number 402, the first UE may transmit, to the second UE, one or more AGC symbols at an AGC candidate location based at least in part on an AGC slot structure for a sidelink frequency range. The AGC candidate location may be associated with an AGC candidate symbol or an AGC candidate slot. A periodicity of the AGC candidate location may be configured in terms of a quantity of slots. The AGC slot structure may be a dynamic AGC slot structure with common and periodic AGC candidate locations. The AGC slot structure may be dynamic because certain AGC slots may be dynamically overwritten as PSCCH/PSSCH slots, depending on sidelink transmissions being transmitted. The second UE may receive the one or more AGC symbols at the AGC candidate location based at least in part on an AGC slot structure for a sidelink frequency range. The second UE may perform an AGC training based at least in part on the one or more AGC symbols at the AGC candidate location.

In some aspects, the first UE and the second UE may be configured with the AGC slot structure for the sidelink frequency range. For example, the first UE and the second UE may receive, from a network node, a configuration that configures the first UE and the second UE with the AGC slot structure for the sidelink frequency range, respectively, where the AGC slot structure may be associated with the common and periodic AGC candidate locations. Alternatively, the first UE and the second UE may be preconfigured with the AGC slot structure for the sidelink frequency range.

As shown by reference number 404, the first UE may transmit, to the second UE, a PSCCH transmission, a PSSCH transmission, and/or a PSFCH transmission based at least in part on the AGC slot structure for the sidelink frequency range. The first UE may transmit the PSCCH transmission, the PSSCH transmission, and/or the PSFCH transmission after the AGC symbols at the AGC candidate location are transmitted to the second UE. For example, an AGC slot may be immediately followed by one or more PSCCH/PSSCH slots, which may be associated with the PSCCH transmission or the PSSCH transmission.

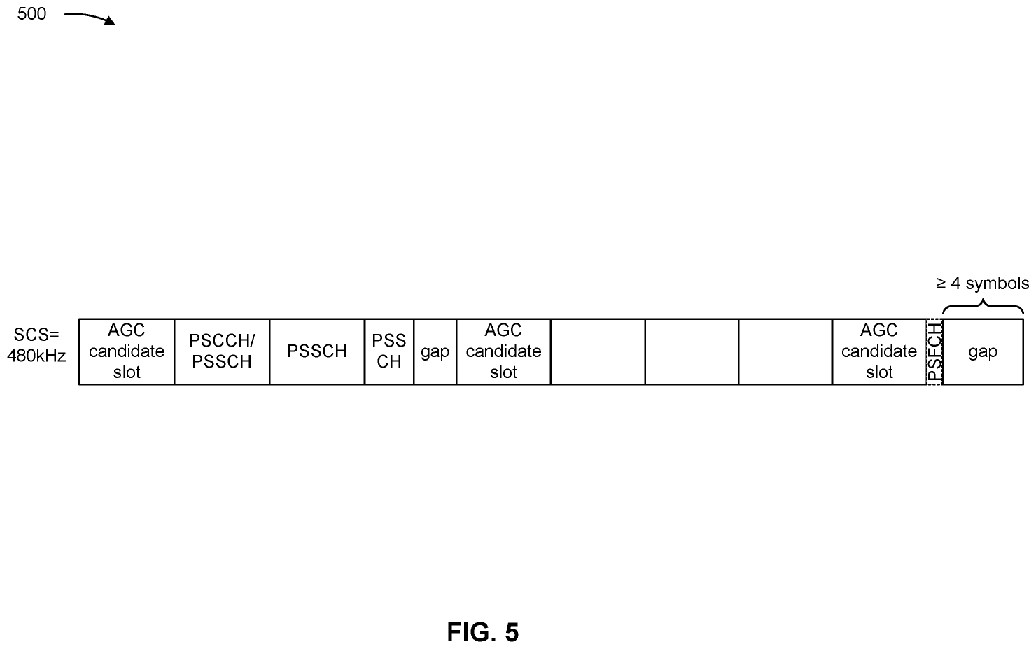

In some aspects, the first UE and the second UE may rely on a common understanding of AGC symbol locations for AGC symbol transmissions and AGC training. Multiple symbols may be used for AGC training in FR2-2, so the density of AGC occasions may be reduced. In some aspects, the first UE may utilize common and periodic AGC candidate symbols/slots. The common and periodic AGC candidate symbols/slots may be introduced across a network. The periodicity of AGC candidate symbols/slots may be configured in terms of symbols/slots (e.g., four symbols/slots). A transmission of AGC symbols/slots may be within AGC candidate locations. An AGC candidate location may be associated with an AGC candidate symbol/slot. In some aspects, the first UE (e.g., a transmitter) may transmit, to the second UE, a PSCCH/PSSCH transmission (e.g., the PSCCH transmission or the PSSCH transmission) or the PSFCH transmission, including AGC symbols/slots, starting from one of the AGC candidate locations. An example of the common and periodic AGC candidate symbols/slots is shown in FIG. 5.

In some aspects, to support starting the PSCCH/PSSCH transmission or the PSFCH transmission at one of the AGC candidate locations (e.g., any AGC candidate location) depending on need, a common AGC design may be implemented for both the PSCCH/PSSCH and the PSFCH. In some aspects, a common AGC symbol/slot structure or symbol location may be defined for both the PSCCH/PSSCH and the PSFCH for different numerologies. Both the PSCCH/PSSCH and the PSFCH may start with the same quantity of AGC symbols, depending on the numerology, and these AGC symbols may start at the same AGC candidate location.

In some aspects, the AGC slot structure may be associated with a 120 kHz SCS, a 480 kHz SCS, or a 960 kHz SCS. In some aspects, the AGC slot structure may define, for a first numerology (e.g., the 120 KHz SCS), a PSCCH or PSSCH slot that includes a multi-symbol AGC (e.g., a four symbol AGC), a PSCCH or a PSSCH, and a gap of one symbol, and a PSFCH slot that includes a multi-symbol AGC (e.g., a four symbol AGC), a one or two symbol PSFCH, and a gap of more than one symbol. In some aspects, the AGC slot structure may define, for a second numerology (e.g., the 480 KHz SCS), PSCCH or PSSCH slots that include one AGC slot, multiple PSCCH or PSSCH slots, and a transmit or receive switching gap of four or more symbols in a last PSCCH or PSSCH slot, and PSFCH slots that include one AGC slot, and one slot that contains a PSFCH and a gap of four or more symbols. In some aspects, the AGC slot structure may define, for a third numerology (e.g., the 960 KHz SCS), PSCCH or PSSCH slots that include two or more AGC slots, multiple PSCCH or PSSCH slots, and a transmit or receive switching gap of eight or more symbols in a last PSCCH or PSSCH slot, and PSFCH slots that include one AGC slot, and one slot that contains a PSFCH and a gap of eight or more symbols.

In some aspects, at least 4, 14, or 28 AGC symbols may be needed before the PSCCH/PSSCH or before the PSFCH for the 120 kHz SCS, the 480 kHz SCS, or the 960 kHz SCS, and 1, 4, or 8 gap symbols may be needed after the PSCCH/PSSCH or after the PSFCH (e.g., after a PSFCH symbol burst).

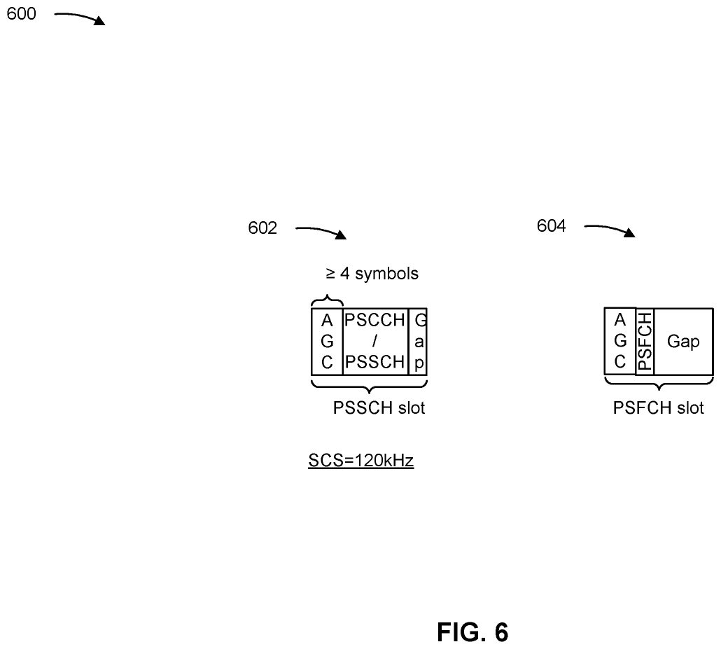

For the 120 kHz SCS, a PSCCH/PSSCH slot may start with a 4 symbol AGC, a PSCCH/PSSCH, and a 1 symbol gap in a last PSCCH/PSSCH slot. For the 120 kHz SCS, a PSFCH slot may include a 4 symbol AGC, a one or two symbol PSFCH, and gap symbols. An example of the PSCCH/PSSCH slot and the PSFCH slot for the 120 kHz SCS is shown in FIG. 6.

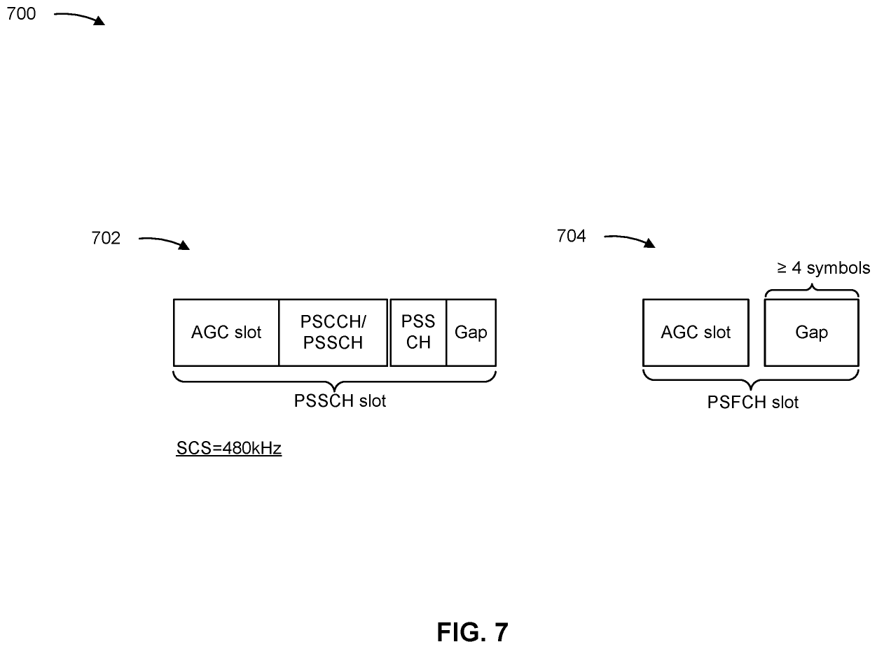

For the 480 kHz SCS, a group of PSCCH/PSSCH slots may include one AGC slot, multiple PSCCH/PSSCH slots, and a Tx/Rx gap in a last PSCCH/PSSCH slot, where the Tx/Rx gap may be four or more symbols. For the 480 kHz SCS, a group of PSFCH slots may include one AGC slot for PSFCH, which may be followed by a slot containing a PSFCH and a Tx/Rx gap, where the Tx/Rx gap may be four or more symbols. An example of the group of PSCCH/PSSCH slots and the group of PSFCH slots for the 480 kHz SCS is shown in FIG. 7.

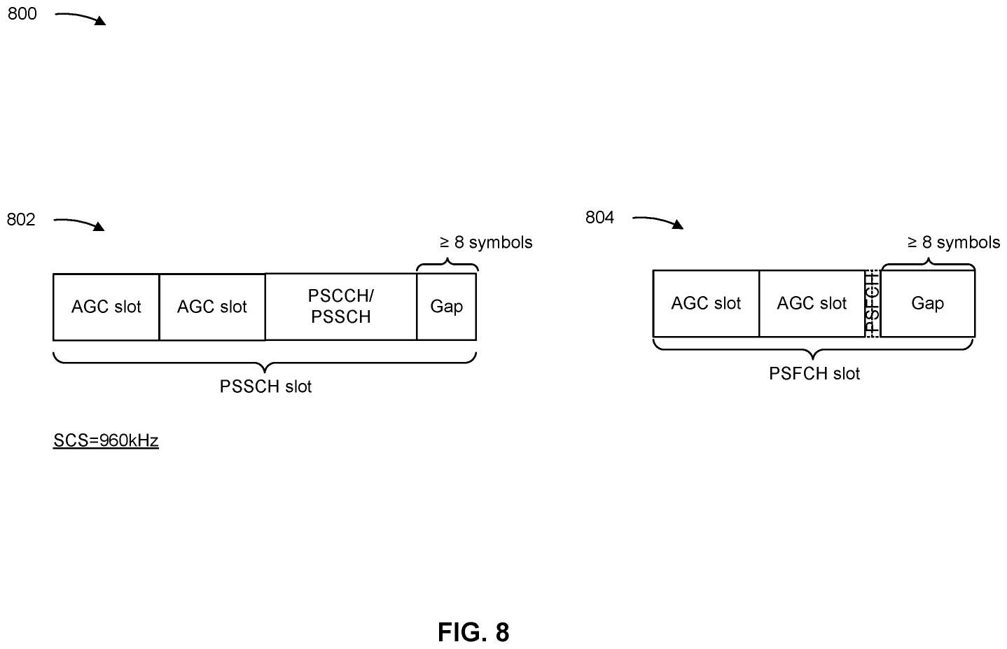

For the 960 kHz SCS, a group of PSCCH/PSSCH slots may include two or more AGC slots, multiple PSCCH/PSSCH slots, and a Tx/Rx gap in a last PSCCH/PSSCH slot, where the Tx/Rx gap may be 8 or more symbols. For the 960 kHz SCS, a group of PSFCH slots may include two or more AGC slots for PSFCH, which may be followed by a slot containing a PSFCH and a Tx/Rx gap, where the Tx/Rx gap may be 8 or more symbols. An example of the group of PSCCH/PSSCH slots and the group of PSFCH slots for the 960 kHz SCS is shown in FIG. 8.

In some aspects, the first UE may detect that the PSSCH transmission is a multiple slot PSSCH transmission. For example, the PSSCH transmission may span three or four slots. The first UE may detect that the AGC candidate location occurs in a middle of the multiple slot PSSCH transmission, where the AGC candidate location may be associated with an AGC candidate symbol or slot. For example, the first UE may detect that an AGC slot occurs in the middle of a four slot PSSCH transmission, such that the AGC slot may be in between a first two PSSCH slots and a last two PSSCH slots. The first UE may replace the AGC candidate symbol or slot in the middle of the multiple slot PSSCH transmission with a PSSCH symbol or slot, which may allow the first UE to perform the multiple slot PSSCH transmission in contiguous slots.

In some aspects, the AGC candidate location may be in the middle of the multiple slot PSSCH transmission, where the multiple slot PSSCH transmission may be associated with a PSSCH data burst. In some aspects, the first UE may transmit AGC symbols in the AGC candidate location, and the second UE may perform an AGC training at the AGC candidate location. For example, a sidelink transmitter may always transmit the AGC symbols in the AGC candidate location, and a sidelink receiver may ways perform the AGC training at the AGC candidate location. When the first UE transmits the AGC in the AGC candidate location and the second UE performs the AGC training in the AGC candidate location, an increased AGC overhead may be an issue for relatively high SCSs (e.g., the 120 kHz SCS, the 480 kHz SCS, or the 960 kHz SCS).

In some aspects, AGC candidate symbols/slots may be dynamically overwritten by other sidelink channels. An AGC candidate slot that is in the middle of the multiple slot PSSCH transmission may be replaced by a PSSCH slot. Due to a relatively narrow receive beam in FR2-2, the second UE may not need to retrain the AGC in the middle of the multiple slot PSSCH transmission. For example, the receiver may be less likely to need to retrain the AGC in the middle of the PSSCH data burst. Other links may have different transmit-receive beam pairs, and may be less likely to cause interference, even when the other links are associated with sidelink transmissions that start in the middle of the multiple slot PSSCH transmission.

In some aspects, the first UE may detect that the PSSCH transmission is the multiple slot PSSCH transmission. The first UE may detect that the AGC candidate location occurs in the middle of the multiple slot PSSCH transmission, where the AGC candidate location may be associated with the AGC candidate symbol or slot. The first UE may transmit, to the second UE, an indication of an AGC usage associated with the AGC candidate symbol or slot in the middle of the multiple slot PSSCH transmission. In this case, the first UE may determine to use an AGC slot in the middle of the multiple slot PSSCH transmission for AGC purposes, and may not replace the AGC slot with a PSSCH slot. The first UE may indicate, to the second UE, that the AGC slot is indeed being used for AGC and is not being replaced with the PSSCH slot.

In some aspects, the other links may possibly cause an AGC misalignment in the middle of the multiple slot PSSCH transmission, in which case the first UE may dynamically transmit in the AGC candidate location in the middle of the multiple slot PSSCH transmission. The first UE may indicate, to the second UE and via sidelink control information (SCI), that the first UE is transmitting AGC symbols at the AGC candidate location in the middle of the multiple slot PSSCH transmission. The first UE may use a multiple transmission time interval (TTI) SCI part 1 (SCI-1) or SCI part 2 (SCI-2) to dynamically indicate, to the second UE, an AGC candidate slot usage associated with the AGC candidate location in the middle of the multiple slot PSSCH transmission. The SCI may provide a dynamic indication of the AGC candidate slot usage. The dynamic indication of the AGC candidate slot usage may indicate that the AGC candidate location in the middle of the multiple slot PSSCH transmission is to be used for transmitting AGC symbols. For example, the first UE may indicate, to the second UE, when the AGC slot is transmitted in the middle of the multiple slot PSSCH transmission using a one-bit field of SCI. An allocation of scheduled PSSCH slots may skip that AGC slot in the middle of the multiple slot PSSCH transmission.

In some aspects, the AGC slot structure may be associated with a dynamic PSFCH slot that occurs after the AGC candidate location. The dynamic PSFCH slot may be based at least in part on one or more scheduled PSSCH slots. The dynamic PSFCH slot may be based at least in part on an AGC candidate location periodicity.

In some aspects, for a periodic PSFCH occasion, an increased AGC overhead may be an issue for relatively high SCSs (e.g., the 120 kHz SCS, the 480 kHz SCS, or the 960 KHz SCS). A longer PSFCH periodicity may be configured, but may result in a longer latency. In some aspects, the dynamic PSFCH slot may start at the AGC candidate location. The first UE may transmit, to the second UE, a PSSCH transmission using scheduled PSSCH slot(s), which may follow one AGC candidate location. The first UE may also transmit, to the second UE, SCI that indicates a K0 value, where the K0 value may be in terms of the AGC candidate location periodicity. Depending on the K0 value, the second UE may be notified that a subsequent AGC candidate location is to be associated with the dynamic PSFCH slot. The first UE and the second UE may use the dynamic PSFCH slot to receive and transmit feedback, respectively for the scheduled PSSCH slot(s). The dynamic PSFCH slot may carry an acknowledgement (ACK) or negative acknowledgement (NACK), or a hybrid automatic repeat request (HARQ) codebook associated with the scheduled PSSCH slot(s). For example, a physical uplink control channel (PUCCH) format 2 based PSFCH may occupy one or two symbols and may carry multiple ACKs or NACKs. Further, the SCI may indicate a PSFCH resource or a PSFCH resource set. A PSFCH hashing may be allowed based at least in part on link identifiers, such as transmit/receive layer 1 (L1) link identifiers. The PSFCH resource set may be indicated in SCI first, and then the PSFCH hashing may be performed within the indicated PSFCH resource set.

As indicated above, FIG. 4 is provided as an example. Other examples may differ from what is described with regard to FIG. 4.

FIG. 5 is a diagram illustrating an example 500 associated with AGC slot structures for sidelink frequency ranges, in accordance with the present disclosure.

As shown in FIG. 5, for an SCS (e.g., 480 kHz), common and periodic AGC candidate locations may be defined. An AGC candidate slot may be defined with a periodicity of four symbols/slots. For example, a first symbol/slot may be associated with an AGC candidate slot, a second symbol/slot may be associated with a PSCCH/PSSCH, a third symbol/slot may be associated with a PSSCH, and a fourth symbol/slot may be associated with a PSSCH/gap. After the fourth symbol/slot, another AGC candidate slot may occur, and so on. AGC symbols may be transmitted within the common and periodic AGC candidate locations (e.g., the first symbol/slot). PSCCH and/or PSSCH transmissions, along with AGC symbol/slot transmissions, may occur starting from the common and periodic AGC candidate locations (e.g., the first symbol/slot). Further, a last slot may include a PSFCH and a gap, where the gap may be associated with four or more symbols.

As indicated above, FIG. 5 is provided as an example. Other examples may differ from what is described with regard to FIG. 5.

FIG. 6 is a diagram illustrating an example 600 associated with AGC slot structures for sidelink frequency ranges, in accordance with the present disclosure.

As shown by reference number 602, for a 120 kHz SCS, a PSCCH/PSSCH slot may include AGC symbols (e.g., four or more AGC symbols), a PSCCH/PSSCH, and a gap. As shown by reference number 604, for the 120 kHz SCS, a PSFCH slot may include AGC symbols (e.g., four or more AGC symbols), a PSFCH (e.g., a one-symbol PSFCH), and a gap.

As indicated above, FIG. 6 is provided as an example. Other examples may differ from what is described with regard to FIG. 6.

FIG. 7 is a diagram illustrating an example 700 associated with AGC slot structures for sidelink frequency ranges, in accordance with the present disclosure.

As shown by reference number 702, for a 480 kHz SCS, a group of PSCCH/PSSCH slots may include three slots. A first PSCCH/PSSCH slot, of the group of PSCCH/PSSCH slots, may be an AGC slot. The AGC slot may include 14 symbols. A PSCCH/PSSCH second slot, of the group of PSCCH/PSSCH slots, may be a PSCCH/PSSCH slot. A third PSCCH/PSSCH slot, of the group of PSCCH/PSSCH slots, may be associated with a PSCCH/PSSCH and a gap.

As shown by reference number 704, for the 480 kHz SCS, a group of PSFCH slots may include two slots. A first PSFCH slot, of the group of PSFCH slots, may be an AGC slot. The AGC slot may include 14 symbols. A second PSFCH slot, of the group of PSFCH slots, may be associated with a PSFCH and a gap, where the gap may be associated with four or more symbols.

As indicated above, FIG. 7 is provided as an example. Other examples may differ from what is described with regard to FIG. 7.

FIG. 8 is a diagram illustrating an example 800 associated with AGC slot structures for sidelink frequency ranges, in accordance with the present disclosure.

As shown by reference number 802, for a 960 kHz SCS, a group of PSCCH/PSSCH slots may include four slots. A first PSCCH/PSSCH slot, of the group of PSCCH/PSSCH slots, may be a first AGC slot. A second PSCCH/PSSCH slot, of the group of PSCCH/PSSCH slots, may be a second AGC slot. The first AGC slot and the second AGC slot may each include 14 symbols (28 symbols total). A third PSCCH/PSSCH slot, of the group of PSCCH/PSSCH slots, may be a PSCCH/PSSCH slot. A fourth PSCCH/PSSCH slot, of the group of PSCCH/PSSCH slots, may be associated with a PSCCH/PSSCH and a gap.

As shown by reference number 804, for the 960 kHz SCS, a group of PSFCH slots may include three slots. A first PSFCH slot, of the group of PSFCH slots, may be a first AGC slot. A second PSFCH slot, of the group of PSFCH slots, may be a second AGC slot. The first AGC slot and the second AGC slot may each include 14 symbols (28 symbols total). A third PSFCH slot, of the group of PSFCH slots, may be associated with a PSFCH and a gap, where the gap may be associated with 8 or more symbols.

As indicated above, FIG. 8 is provided as an example. Other examples may differ from what is described with regard to FIG. 8.

FIG. 9 is a diagram illustrating an example process 900 performed, for example, by a first UE, in accordance with the present disclosure. Example process 900 is an example where the first UE (e.g., UE 120a) performs operations associated with AGC slot structures for sidelink frequency ranges.

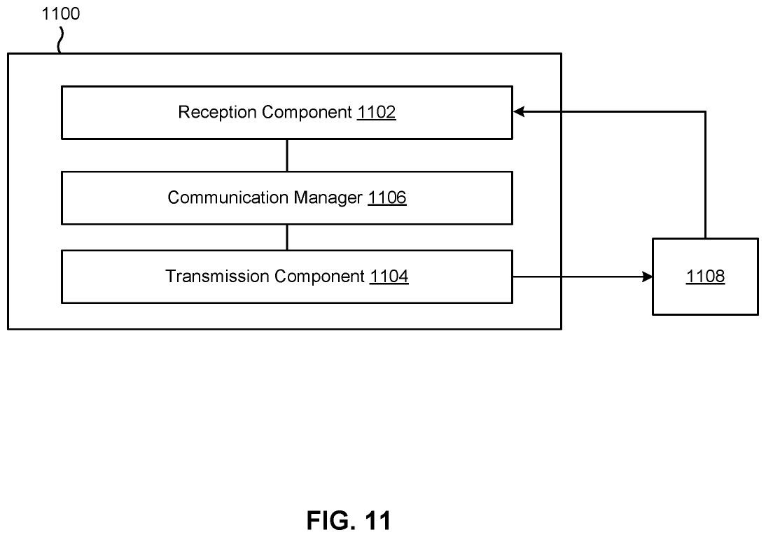

As shown in FIG. 9, in some aspects, process 900 may include transmitting, to a second UE, one or more AGC symbols at an AGC candidate location based at least in part on an AGC slot structure for a sidelink frequency range (block 910). For example, the first UE (e.g., using transmission component 1104 and/or communication manager 1106, depicted in FIG. 11) may transmit, to a second UE, one or more AGC symbols at an AGC candidate location based at least in part on an AGC slot structure for a sidelink frequency range, as described above.

As further shown in FIG. 9, in some aspects, process 900 may include transmitting, to the second UE, one or more of a PSCCH transmission, a PSSCH transmission, or a PSFCH transmission based at least in part on the AGC slot structure for the sidelink frequency range (block 920). For example, the first UE (e.g., using transmission component 1104 and/or communication manager 1106, depicted in FIG. 11) may transmit, to the second UE, one or more of a PSCCH transmission, a PSSCH transmission, or a PSFCH transmission based at least in part on the AGC slot structure for the sidelink frequency range, as described above.

Process 900 may include additional aspects, such as any single aspect or any combination of aspects described below and/or in connection with one or more other processes described elsewhere herein.

In a first aspect, the AGC slot structure is a dynamic AGC slot structure with common and periodic AGC candidate locations.

In a second aspect, alone or in combination with the first aspect, the AGC candidate location is associated with one or more AGC candidate symbols or one or more AGC candidate slots.

In a third aspect, alone or in combination with one or more of the first and second aspects, a periodicity of the AGC candidate location is configured in terms of a quantity of slots.

In a fourth aspect, alone or in combination with one or more of the first through third aspects, process 900 includes transmitting one or more of the PSCCH transmission, the PSSCH transmission, or the PSFCH transmission after transmitting the AGC symbols at the AGC candidate location.

In a fifth aspect, alone or in combination with one or more of the first through fourth aspects, the AGC slot structure defines a common AGC symbol or slot structure or a symbol location for a PSSCH or a PSCCH, and a PSFCH, depending on a numerology.

In a sixth aspect, alone or in combination with one or more of the first through fifth aspects, the PSSCH or the PSCCH, and the PSFCH, start with a same quantity of AGC symbols, depending on the numerology.

In a seventh aspect, alone or in combination with one or more of the first through sixth aspects, the AGC slot structure is associated with one of a 120 kHz SCS, a 480 kHz SCS, or a 960 kHz SCS.

In an eighth aspect, alone or in combination with one or more of the first through seventh aspects, the AGC slot structure defines, for a first numerology, a PSCCH or PSSCH slot that includes a multi-symbol AGC, a PSCCH or a PSSCH, and a gap of one symbol, and a PSFCH slot that includes a multi-symbol AGC, a one or two symbol PSFCH, and a gap of more than one symbol.

In a ninth aspect, alone or in combination with one or more of the first through eighth aspects, the AGC slot structure defines, for a second numerology, PSCCH or PSSCH slots that include one AGC slot, multiple PSCCH or PSSCH slots, and a transmit or receive switching gap of four or more symbols in a last PSCCH or PSSCH slot, and PSFCH slots that include one AGC slot, and one slot that contains a PSFCH and a gap of four or more symbols.

In a tenth aspect, alone or in combination with one or more of the first through ninth aspects, the AGC slot structure defines, for a third numerology, PSCCH or

PSSCH slots that include two or more AGC slots, multiple PSCCH or PSSCH slots, and a transmit or receive switching gap of eight or more symbols in a last PSCCH or PSSCH slot, and PSFCH slots that include one AGC slot, and one slot that contains a PSFCH and a gap of eight or more symbols.

In an eleventh aspect, alone or in combination with one or more of the first through tenth aspects, process 900 includes detecting that the PSSCH transmission is a multiple slot PSSCH transmission, detecting that the AGC candidate location occurs in a middle of the multiple slot PSSCH transmission, the AGC candidate location being associated with an AGC candidate symbol or slot, and replacing the AGC candidate symbol or slot in the middle of the multiple slot PSSCH transmission with a PSSCH symbol or slot.

In a twelfth aspect, alone or in combination with one or more of the first through eleventh aspects, process 900 includes detecting that the PSSCH transmission is a multiple slot PSSCH transmission, detecting that the AGC candidate location occurs in a middle of the multiple slot PSSCH transmission, the AGC candidate location being associated with an AGC candidate symbol or slot, and transmitting, to the second UE, an indication of an AGC usage associated with the AGC candidate symbol or slot in the middle of the multiple slot PSSCH transmission.

In a thirteenth aspect, alone or in combination with one or more of the first through twelfth aspects, the AGC slot structure is associated with a dynamic PSFCH slot that occurs after the AGC candidate location, the dynamic PSFCH slot being based at least in part on one or more scheduled PSSCH slots, the dynamic PSFCH slot being further based at least in part on an AGC candidate location periodicity.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a second UE, in accordance with the present disclosure. Example process 1000 is an example where the second UE (e.g., UE 120c) performs operations associated with AGC slot structures for sidelink frequency ranges.

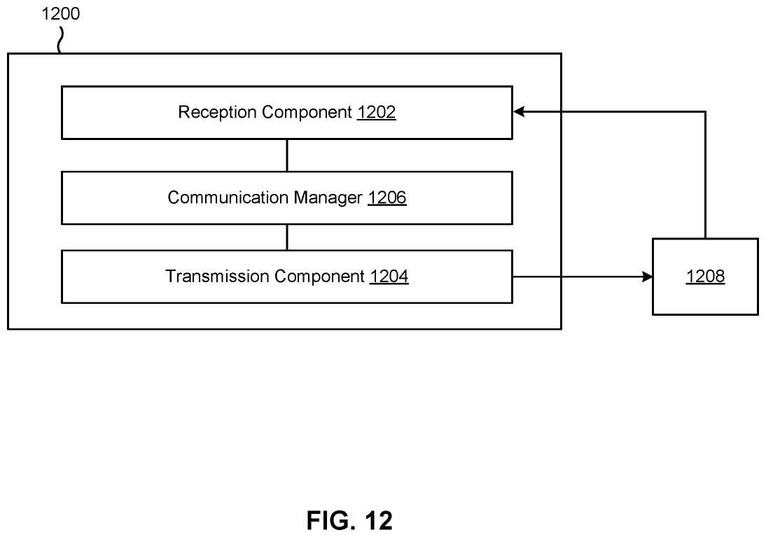

As shown in FIG. 10, in some aspects, process 1000 may include receiving, from a first UE, one or more AGC symbols at an AGC candidate location based at least in part on an AGC slot structure for a sidelink frequency range, an AGC training being based at least in part on the one or more AGC symbols at the AGC candidate location (block 1010). For example, the second UE (e.g., using reception component 1202 and/or communication manager 1206, depicted in FIG. 12) may receive, from a first UE, one or more AGC symbols at an AGC candidate location based at least in part on an AGC slot structure for a sidelink frequency range, an AGC training being based at least in part on the one or more AGC symbols at the AGC candidate location, as described above.

As further shown in FIG. 10, in some aspects, process 1000 may include receiving, from the first UE, one or more of a PSCCH transmission, a PSSCH transmission, or a PSFCH transmission based at least in part on the AGC slot structure for the sidelink frequency range (block 1020). For example, the second UE (e.g., using reception component 1202 and/or communication manager 1206, depicted in FIG. 12) may receive, from the first UE, one or more of a PSCCH transmission, a PSSCH transmission, or a PSFCH transmission based at least in part on the AGC slot structure for the sidelink frequency range, as described above.

Process 1000 may include additional aspects, such as any single aspect or any combination of aspects described below and/or in connection with one or more other processes described elsewhere herein.

In a first aspect, the AGC slot structure is a dynamic AGC slot structure with common and periodic AGC candidate locations.

In a second aspect, alone or in combination with the first aspect, the AGC candidate location is associated with one or more AGC candidate symbols or one or more AGC candidate slots.

In a third aspect, alone or in combination with one or more of the first and second aspects, a periodicity of the AGC candidate location is configured in terms of a quantity of slots.

In a fourth aspect, alone or in combination with one or more of the first through third aspects, process 1000 includes receiving one or more of the PSCCH transmission, the PSSCH transmission, or the PSFCH transmission after receiving the AGC symbols at the AGC candidate location.

In a fifth aspect, alone or in combination with one or more of the first through fourth aspects, the AGC slot structure defines a common AGC symbol or slot structure or a symbol location for a PSSCH or a PSCCH, and a PSFCH, depending on a numerology.

In a sixth aspect, alone or in combination with one or more of the first through fifth aspects, the PSSCH or the PSCCH, and the PSFCH, start with a same quantity of AGC symbols, depending on the numerology.

In a seventh aspect, alone or in combination with one or more of the first through sixth aspects, the AGC slot structure is associated with one of a 120 kHz SCS, a 480 kHz SCS, or a 960 KHz SCS.

In an eighth aspect, alone or in combination with one or more of the first through seventh aspects, the AGC slot structure defines, for a first numerology, a PSCCH or PSSCH slot that includes a multi-symbol AGC, a PSCCH or a PSSCH, and a gap of one symbol, and a PSFCH slot that includes a multi-symbol AGC, a one or two symbol PSFCH, and a gap of more than one symbol.

In a ninth aspect, alone or in combination with one or more of the first through eighth aspects, the AGC slot structure defines, for a second numerology, PSCCH or PSSCH slots that include one AGC slot, multiple PSCCH or PSSCH slots, and a transmit or receive switching gap of four or more symbols in a last PSCCH or PSSCH slot, and PSFCH slots that include one AGC slot, and one slot that contains a PSFCH and a gap of four or more symbols.

In a tenth aspect, alone or in combination with one or more of the first through ninth aspects, the AGC slot structure defines, for a third numerology, PSCCH or PSSCH slots that include two or more AGC slots, multiple PSCCH or PSSCH slots, and a transmit or receive switching gap of eight or more symbols in a last PSCCH or PSSCH slot, and PSFCH slots that include one AGC slot, and one slot that contains a PSFCH and a gap of eight or more symbols.

In an eleventh aspect, alone or in combination with one or more of the first through tenth aspects, the PSSCH transmission is a multiple slot PSSCH transmission, the AGC candidate location occurring in a middle of the multiple slot PSSCH transmission, the AGC candidate location being associated with an AGC candidate symbol or slot, and the AGC candidate symbol or slot in the middle of the multiple slot PSSCH transmission being replaced with a PSSCH symbol or slot.

In a twelfth aspect, alone or in combination with one or more of the first through eleventh aspects, the PSSCH transmission is a multiple slot PSSCH transmission, the AGC candidate location occurring in a middle of the multiple slot PSSCH transmission, and the AGC candidate location being associated with an AGC candidate symbol or slot, and further comprising receiving, from the first UE, an indication of an AGC usage associated with the AGC candidate symbol or slot in the middle of the multiple slot PSSCH transmission.

In a thirteenth aspect, alone or in combination with one or more of the first through twelfth aspects, the AGC slot structure is associated with a dynamic PSFCH slot that occurs after the AGC candidate location, the dynamic PSFCH slot being based at least in part on one or more scheduled PSSCH slots, the dynamic PSFCH slot being further based at least in part on an AGC candidate location periodicity.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a first UE, or a first UE may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 140 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 4-8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the first UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the first UE described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, a modem, a modulator, a transmit MIMO processor, a transmit processor, a controller/processor, a memory, or a combination thereof, of the first UE described in connection with FIG. 2. In some aspects, the transmission component 1104 may be co-located with the reception component 1102 in a transceiver.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The transmission component 1104 may transmit, to a second UE, one or more AGC symbols at an AGC candidate location based at least in part on an AGC slot structure for a sidelink frequency range. The transmission component 1104 may transmit, to the second UE, one or more of a PSCCH transmission, a PSSCH transmission, or a PSFCH transmission based at least in part on the AGC slot structure for the sidelink frequency range.

The communication manager 1106 may detect that the PSSCH transmission is a multiple slot PSSCH transmission. The communication manager 1106 may detect that the AGC candidate location occurs in a middle of the multiple slot PSSCH transmission, the AGC candidate location being associated with an AGC candidate symbol or slot. The communication manager 1106 may replace the AGC candidate symbol or slot in the middle of the multiple slot PSSCH transmission with a PSSCH symbol or slot.

The communication manager 1106 may detect that the PSSCH transmission is a multiple slot PSSCH transmission. The communication manager 1106 may detect that the AGC candidate location occurs in a middle of the multiple slot PSSCH transmission, the AGC candidate location being associated with an AGC candidate symbol or slot. The transmission component 1104 may transmit, to the second UE, an indication of an AGC usage associated with the AGC candidate symbol or slot in the middle of the multiple slot PSSCH transmission.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be a second UE, or a second UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 4-8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the second UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the second UE described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the second UE described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive, from a first UE, one or more AGC symbols at an AGC candidate location based at least in part on an AGC slot structure for a sidelink frequency range, an AGC training being based at least in part on the one or more AGC symbols at the AGC candidate location. The reception component 1202 may receive, from the first UE, one or more of a PSCCH transmission, a PSSCH transmission, or a PSFCH transmission based at least in part on the AGC slot structure for the sidelink frequency range.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a first user equipment (UE), comprising: transmitting, to a second UE, one or more automatic gain control (AGC) symbols at an AGC candidate location based at least in part on an AGC slot structure for a sidelink frequency range; and transmitting, to the second UE, one or more of a physical sidelink control channel (PSCCH) transmission, a physical sidelink shared channel (PSSCH) transmission, or a physical sidelink feedback channel (PSFCH) transmission based at least in part on the AGC slot structure for the sidelink frequency range.

Aspect 2: The method of Aspect 1, wherein the AGC slot structure is a dynamic AGC slot structure with common and periodic AGC candidate locations.

Aspect 3: The method of any of Aspects 1-2, wherein the AGC candidate location is associated with one or more AGC candidate symbols or one or more AGC candidate slots.

Aspect 4: The method of any of Aspects 1-3, wherein a periodicity of the AGC candidate location is configured in terms of a quantity of slots.

Aspect 5: The method of any of Aspects 1-4, wherein transmitting one or more of the PSCCH transmission, the PSSCH transmission, or the PSFCH transmission after transmitting the AGC symbols at the AGC candidate location.

Aspect 6: The method of any of Aspects 1-5, wherein the AGC slot structure defines a common AGC symbol or slot structure or a symbol location for a PSSCH or a PSCCH, and a PSFCH, depending on a numerology.

Aspect 7: The method of Aspect 6, wherein the PSSCH or the PSCCH, and the PSFCH, start with a same quantity of AGC symbols, depending on the numerology.

Aspect 8: The method of any of Aspects 1-7, wherein the AGC slot structure is associated with one of: a 120 kilohertz (kHz) subcarrier spacing (SCS), a 480 kHz SCS, or a 960 KHz SCS.

Aspect 9: The method of any of Aspects 1-8, wherein the AGC slot structure defines, for a first numerology, a PSCCH or PSSCH slot that includes a multi-symbol AGC, a PSCCH or a PSSCH, and a gap of one symbol, and a PSFCH slot that includes a multi-symbol AGC, a one or two symbol PSFCH, and a gap of more than one symbol.

Aspect 10: The method of any of Aspects 1-9, wherein the AGC slot structure defines, for a second numerology, PSCCH or PSSCH slots that include one AGC slot, multiple PSCCH or PSSCH slots, and a transmit or receive switching gap of four or more symbols in a last PSCCH or PSSCH slot, and PSFCH slots that include one AGC slot, and one slot that contains a PSFCH and a gap of four or more symbols.

Aspect 11: The method of any of Aspects 1-10, wherein the AGC slot structure defines, for a third numerology, PSCCH or PSSCH slots that include two or more AGC slots, multiple PSCCH or PSSCH slots, and a transmit or receive switching gap of eight or more symbols in a last PSCCH or PSSCH slot, and PSFCH slots that include one AGC slot, and one slot that contains a PSFCH and a gap of eight or more symbols.

Aspect 12: The method of any of Aspects 1-11, further comprising: detecting that the PSSCH transmission is a multiple slot PSSCH transmission; detecting that the AGC candidate location occurs in a middle of the multiple slot PSSCH transmission, the AGC candidate location being associated with an AGC candidate symbol or slot; and replacing the AGC candidate symbol or slot in the middle of the multiple slot PSSCH transmission with a PSSCH symbol or slot.

Aspect 13: The method of any of Aspects 1-12, further comprising: detecting that the PSSCH transmission is a multiple slot PSSCH transmission; detecting that the AGC candidate location occurs in a middle of the multiple slot PSSCH transmission, the AGC candidate location being associated with an AGC candidate symbol or slot; and transmitting, to the second UE, an indication of an AGC usage associated with the AGC candidate symbol or slot in the middle of the multiple slot PSSCH transmission.

Aspect 14: The method of any of Aspects 1-13, wherein the AGC slot structure is associated with a dynamic PSFCH slot that occurs after the AGC candidate location, the dynamic PSFCH slot being based at least in part on one or more scheduled PSSCH slots, the dynamic PSFCH slot being further based at least in part on an AGC candidate location periodicity.

Aspect 15: A method of wireless communication performed by a second user equipment (UE), comprising: receiving, from a first UE, one or more automatic gain control (AGC) symbols at an AGC candidate location based at least in part on an AGC slot structure for a sidelink frequency range, an AGC training being based at least in part on the one or more AGC symbols at the AGC candidate location; and receiving, from the first UE, one or more of a physical sidelink control channel (PSCCH) transmission, a physical sidelink shared channel (PSSCH) transmission, or a physical sidelink feedback channel (PSFCH) transmission based at least in part on the AGC slot structure for the sidelink frequency range.

Aspect 16: The method of Aspect 15, wherein the AGC slot structure is a dynamic AGC slot structure with common and periodic AGC candidate locations.

Aspect 17: The method of any of Aspects 15-16, wherein the AGC candidate location is associated with one or more AGC candidate symbols or one or more AGC candidate slots.

Aspect 18: The method of any of Aspects 15-17, wherein a periodicity of the AGC candidate location is configured in terms of a quantity of slots.

Aspect 19: The method of any of Aspects 15-18, wherein receiving one or more of the PSCCH transmission, the PSSCH transmission, or the PSFCH transmission after receiving the AGC symbols at the AGC candidate location.

Aspect 20: The method of any of Aspects 15-19, wherein the AGC slot structure defines a common AGC symbol or slot structure or a symbol location for a PSSCH or a PSCCH, and a PSFCH, depending on a numerology.

Aspect 21: The method of Aspect 20, wherein the PSSCH or the PSCCH, and the PSFCH, start with a same quantity of AGC symbols, depending on the numerology.

Aspect 22: The method of any of Aspects 15-21, wherein the AGC slot structure is associated with one of: a 120 kilohertz (kHz) subcarrier spacing (SCS), a 480 kHz SCS, or a 960 kHz SCS.

Aspect 23: The method of any of Aspects 15-22, wherein the AGC slot structure defines, for a first numerology, a PSCCH or PSSCH slot that includes a multi-symbol AGC, a PSCCH or a PSSCH, and a gap of one symbol, and a PSFCH slot that includes a multi-symbol AGC, a one or two symbol PSFCH, and a gap of more than one symbol.

Aspect 24: The method of any of Aspects 15-23, wherein the AGC slot structure defines, for a second numerology, PSCCH or PSSCH slots that include one AGC slot, multiple PSCCH or PSSCH slots, and a transmit or receive switching gap of four or more symbols in a last PSCCH or PSSCH slot, and PSFCH slots that include one AGC slot, and one slot that contains a PSFCH and a gap of four or more symbols.

Aspect 25: The method of any of Aspects 15-24, wherein the AGC slot structure defines, for a third numerology, PSCCH or PSSCH slots that include two or more AGC slots, multiple PSCCH or PSSCH slots, and a transmit or receive switching gap of eight or more symbols in a last PSCCH or PSSCH slot, and PSFCH slots that include one AGC slot, and one slot that contains a PSFCH and a gap of eight or more symbols.

Aspect 26: The method of any of Aspects 15-25, wherein the PSSCH transmission is a multiple slot PSSCH transmission, the AGC candidate location occurring in a middle of the multiple slot PSSCH transmission, the AGC candidate location being associated with an AGC candidate symbol or slot, and the AGC candidate symbol or slot in the middle of the multiple slot PSSCH transmission being replaced with a PSSCH symbol or slot.

Aspect 27: The method of any of Aspects 15-26, wherein the PSSCH transmission is a multiple slot PSSCH transmission, the AGC candidate location occurring in a middle of the multiple slot PSSCH transmission, and the AGC candidate location being associated with an AGC candidate symbol or slot, and further comprising: receiving, from the first UE, an indication of an AGC usage associated with the AGC candidate symbol or slot in the middle of the multiple slot PSSCH transmission.

Aspect 28: The method of any of Aspects 15-27, wherein the AGC slot structure is associated with a dynamic PSFCH slot that occurs after the AGC candidate location, the dynamic PSFCH slot being based at least in part on one or more scheduled PSSCH slots, the dynamic PSFCH slot being further based at least in part on an AGC candidate location periodicity.

Aspect 29: An apparatus for wireless communication at a device, comprising a processor; memory coupled with the processor; and instructions stored in the memory and executable by the processor to cause the apparatus to perform the method of one or more of Aspects 1-14.

Aspect 30: A device for wireless communication, comprising a memory and one or more processors coupled to the memory, the one or more processors configured to perform the method of one or more of Aspects 1-14.

Aspect 31: An apparatus for wireless communication, comprising at least one means for performing the method of one or more of Aspects 1-14.

Aspect 32: A non-transitory computer-readable medium storing code for wireless communication, the code comprising instructions executable by a processor to perform the method of one or more of Aspects 1-14.

Aspect 33: A non-transitory computer-readable medium storing a set of instructions for wireless communication, the set of instructions comprising one or more instructions that, when executed by one or more processors of a device, cause the device to perform the method of one or more of Aspects 1-14.

Aspect 34: An apparatus for wireless communication at a device, comprising a processor; memory coupled with the processor; and instructions stored in the memory and executable by the processor to cause the apparatus to perform the method of one or more of Aspects 15-28.

Aspect 35: A device for wireless communication, comprising a memory and one or more processors coupled to the memory, the one or more processors configured to perform the method of one or more of Aspects 15-28.

Aspect 36: An apparatus for wireless communication, comprising at least one means for performing the method of one or more of Aspects 15-28.

Aspect 37: A non-transitory computer-readable medium storing code for wireless communication, the code comprising instructions executable by a processor to perform the method of one or more of Aspects 15-28.

Aspect 38: A non-transitory computer-readable medium storing a set of instructions for wireless communication, the set of instructions comprising one or more instructions that, when executed by one or more processors of a device, cause the device to perform the method of one or more of Aspects 15-28.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a first user equipment (UE), comprising:
a memory; and
one or more processors, coupled to the memory, configured to:
transmit, to a second UE, one or more automatic gain control (AGC) symbols at an AGC candidate location based at least in part on an AGC slot structure for a sidelink frequency range; and
transmit, to the second UE, one or more of a physical sidelink control channel (PSCCH) transmission, a physical sidelink shared channel (PSSCH) transmission, or a physical sidelink feedback channel (PSFCH) transmission based at least in part on the AGC slot structure for the sidelink frequency range.

2. The apparatus of claim 1, wherein the AGC slot structure is a dynamic AGC slot structure with common and periodic AGC candidate locations.

3. The apparatus of claim 1, wherein the AGC candidate location is associated with one or more AGC candidate symbols or one or more AGC candidate slots.

4. The apparatus of claim 1, wherein a periodicity of the AGC candidate location is configured in terms of a quantity of slots.

5. The apparatus of claim 1, wherein the one or more processors are configured to transmit one or more of the PSCCH transmission, the PSSCH transmission, or the PSFCH transmission after the AGC symbols at the AGC candidate location are transmitted.

6. The apparatus of claim 1, wherein the AGC slot structure defines a common AGC symbol or slot structure or a symbol location for a PSSCH or a PSCCH, and a PSFCH, depending on a numerology.

7. The apparatus of claim 6, wherein the PSSCH or the PSCCH, and the PSFCH, start with a same quantity of AGC symbols, depending on the numerology.

8. The apparatus of claim 1, wherein the AGC slot structure is associated with one of: a 120 kilohertz (kHz) subcarrier spacing (SCS), a 480 kHz SCS, or a 960 kHz SCS.

9. The apparatus of claim 1, wherein the AGC slot structure defines, for a first numerology, a PSCCH or PSSCH slot that includes a multi-symbol AGC, a PSCCH or a PSSCH, and a gap of one symbol, and a PSFCH slot that includes a multi-symbol AGC, a one or two symbol PSFCH, and a gap of more than one symbol.

10. The apparatus of claim 1, wherein the AGC slot structure defines, for a second numerology, PSCCH or PSSCH slots that include one AGC slot, multiple PSCCH or PSSCH slots, and a transmit or receive switching gap of four or more symbols in a last PSCCH or PSSCH slot, and PSFCH slots that include one AGC slot, and one slot that contains a PSFCH and a gap of four or more symbols.

11. The apparatus of claim 1, wherein the AGC slot structure defines, for a third numerology, PSCCH or PSSCH slots that include two or more AGC slots, multiple PSCCH or PSSCH slots, and a transmit or receive switching gap of eight or more symbols in a last PSCCH or PSSCH slot, and PSFCH slots that include one AGC slot, and one slot that contains a PSFCH and a gap of eight or more symbols.

12. The apparatus of claim 1, wherein the one or more processors are further configured to:
detect that the PSSCH transmission is a multiple slot PSSCH transmission;
detect that the AGC candidate location occurs in a middle of the multiple slot PSSCH transmission, the AGC candidate location being associated with an AGC candidate symbol or slot; and
replace the AGC candidate symbol or slot in the middle of the multiple slot PSSCH transmission with a PSSCH symbol or slot.

13. The apparatus of claim 1, wherein the one or more processors are further configured to:
detect that the PSSCH transmission is a multiple slot PSSCH transmission;
detect that the AGC candidate location occurs in a middle of the multiple slot PSSCH transmission, the AGC candidate location being associated with an AGC candidate symbol or slot; and
transmit, to the second UE, an indication of an AGC usage associated with the AGC candidate symbol or slot in the middle of the multiple slot PSSCH transmission.

14. The apparatus of claim 1, wherein the AGC slot structure is associated with a dynamic PSFCH slot that occurs after the AGC candidate location, the dynamic PSFCH slot being based at least in part on one or more scheduled PSSCH slots, the dynamic PSFCH slot being further based at least in part on an AGC candidate location periodicity.

15. An apparatus for wireless communication at a second user equipment (UE), comprising:
a memory; and
one or more processors, coupled to the memory, configured to:
receive, from a first UE, one or more automatic gain control (AGC) symbols at an AGC candidate location based at least in part on an AGC slot structure for a sidelink frequency range, an AGC training being based at least in part on the one or more AGC symbols at the AGC candidate location; and
receive, from the first UE, one or more of a physical sidelink control channel (PSCCH) transmission, a physical sidelink shared channel (PSSCH) transmission, or a physical sidelink feedback channel (PSFCH) transmission based at least in part on the AGC slot structure for the sidelink frequency range.

16. The apparatus of claim 15, wherein the AGC slot structure is a dynamic AGC slot structure with common and periodic AGC candidate locations.

17. The apparatus of claim 15, wherein the AGC candidate location is associated with one or more AGC candidate symbols or one or more AGC candidate slots.

18. The apparatus of claim 15, wherein a periodicity of the AGC candidate location is configured in terms of a quantity of slots.

19. The apparatus of claim 15, wherein the one or more processors are configured to receive one or more of the PSCCH transmission, the PSSCH transmission, or the PSFCH transmission after the AGC symbols at the AGC candidate location are received.

20. The apparatus of claim 15, wherein the AGC slot structure defines a common AGC symbol or slot structure or a symbol location for a PSSCH or a PSCCH, and a PSFCH, depending on a numerology.

21. The apparatus of claim 20, wherein the PSSCH or the PSCCH, and the PSFCH, start with a same quantity of AGC symbols, depending on the numerology.

22. The apparatus of claim 15, wherein the AGC slot structure is associated with one of: a 120 kilohertz (kHz) subcarrier spacing (SCS), a 480 kHz SCS, or a 960 kHz SCS.

23. The apparatus of claim 15, wherein the AGC slot structure defines, for a first numerology, a PSCCH or PSSCH slot that includes a multi-symbol AGC, a PSCCH or a PSSCH, and a gap of one symbol, and a PSFCH slot that includes a multi-symbol AGC, a one or two symbol PSFCH, and a gap of more than one symbol.

24. The apparatus of claim 15, wherein the AGC slot structure defines, for a second numerology, PSCCH or PSSCH slots that include one AGC slot, multiple PSCCH or PSSCH slots, and a transmit or receive switching gap of four or more symbols in a last PSCCH or PSSCH slot, and PSFCH slots that include one AGC slot, and one slot that contains a PSFCH and a gap of four or more symbols.

25. The apparatus of claim 15, wherein the AGC slot structure defines, for a third numerology, PSCCH or PSSCH slots that include two or more AGC slots, multiple PSCCH or PSSCH slots, and a transmit or receive switching gap of eight or more symbols in a last PSCCH or PSSCH slot, and PSFCH slots that include one AGC slot, and one slot that contains a PSFCH and a gap of eight or more symbols.

26. The apparatus of claim 15, wherein the PSSCH transmission is a multiple slot PSSCH transmission, the AGC candidate location occurring in a middle of the multiple slot PSSCH transmission, the AGC candidate location being associated with an AGC candidate symbol or slot, and the AGC candidate symbol or slot in the middle of the multiple slot PSSCH transmission being replaced with a PSSCH symbol or slot.

27. The apparatus of claim 15, wherein the PSSCH transmission is a multiple slot PSSCH transmission, the AGC candidate location occurring in a middle of the multiple slot PSSCH transmission, and the AGC candidate location being associated with an AGC candidate symbol or slot, and wherein the one or more processors are further configured to:
receive, from the first UE, an indication of an AGC usage associated with the AGC candidate symbol or slot in the middle of the multiple slot PSSCH transmission.

28. The apparatus of claim 15, wherein the AGC slot structure is associated with a dynamic PSFCH slot that occurs after the AGC candidate location, the dynamic PSFCH slot being based at least in part on one or more scheduled PSSCH slots, the dynamic PSFCH slot being further based at least in part on an AGC candidate location periodicity.

29. A method of wireless communication performed by a first user equipment (UE), comprising:
transmitting, to a second UE, one or more automatic gain control (AGC) symbols at an AGC candidate location based at least in part on an AGC slot structure for a sidelink frequency range; and
transmitting, to the second UE, one or more of a physical sidelink control channel (PSCCH) transmission, a physical sidelink shared channel (PSSCH) transmission, or a physical sidelink feedback channel (PSFCH) transmission based at least in part on the AGC slot structure for the sidelink frequency range.

30. A method of wireless communication performed by a second user equipment (UE), comprising:
receiving, from a first UE, one or more automatic gain control (AGC) symbols at an AGC candidate location based at least in part on an AGC slot structure for a sidelink frequency range, an AGC training being based at least in part on the one or more AGC symbols at the AGC candidate location; and
receiving, from the first UE, one or more of a physical sidelink control channel (PSCCH) transmission, a physical sidelink shared channel (PSSCH) transmission, or a physical sidelink feedback channel (PSFCH) transmission based at least in part on the AGC slot structure for the sidelink frequency range.
